(19) United States
(12) Patent Application Publication
(10) Pub. No.: US 2007/0293603 A1
(43) Pub. Date: Dec. 20, 2007

(54) Epoxy adhesive composition and use thereof

(75) Inventors: Brian D. Shepherd, Marysville, OH (US); Nathan L. Keib, Hilliard, OH (US)

Correspondence Address: Connolly Bove Lodge & Hutz LLP, Suite 800, 1990 M Street, N.W., Washington, DC, 20036, US

(73) Assignee: Ashland Licensing and Intellectual Property LLC, Columbus, OH (US)

(21) Appl. No.: 11/454,876

(22) Filed: Jun. 19, 2006

(51) Int. Cl. C09J 7/02

(52) U.S. Cl. 523/467

(57) ABSTRACT

Epoxy adhesive compositions are provided. Specifically, the composition is a two-part, low-heat cure epoxy structural adhesive composition with a unique, well-balanced array of properties. The composition comprises components (A) and (B) where component (A) comprises at least one compound having an average epoxy functionality of at least two and optionally an epoxy functionalized liquid rubber and where component (B) comprises a polyamine, a polyamide and optionally an epoxy reactive liquid rubber. The compositions are useful as structural adhesives in bonding operations in industrial manufacturing such as automobile manufacturing.

### TECHNICAL FIELD

The present disclosure relates to epoxy adhesive compositions. Specifically, the disclosure relates to a novel two-part, low-heat cure epoxy structural adhesive composition with a unique, well-balanced array of properties. The composition comprises components (A) and (B) where component (A) comprises at least one compound having an average epoxy functionality of at least two and optionally an epoxy functionalized liquid rubber and where component (B) comprises a polyamine, a polyamide and optionally an epoxy reactive liquid rubber. The compositions are useful as structural adhesives in bonding operations in industrial manufacturing such as automobile manufacturing.

### BACKGROUND

Epoxy resins have been widely used in many different commercial and industrial applications. For instance, industrial epoxy adhesives are used to bond a variety of materials together such as metals, plastics and composites.

Various epoxy resin compositions have been proposed as adhesives or bonding agents. Many of these compositions require high temperature cures while others can be cured at ambient temperatures. Some epoxy adhesive compositions are briefly mentioned below.

U.S. Pat. No. 3,257,342 describes epoxy resins cured with polyaminopolyamines from diaminopolyethers and dicarboxylic acids.

U.S. Pat. No. 4,521,490 describes a two-part epoxy composition. The composition contains an epoxide group containing compound having in situ polymerized elastomeric particles and as a curing agent a poly(oxyhydrocarbolene)diamine compound and optionally a cure accelerator.

U.S. Pat. No. 4,766,186 describes an epoxy resin adhesive containing a vicinal polyepoxide of at least 1.8 reactive 1,2-epoxy groups per molecule, a trimethylolpropanetriacrylate and a polyoxypropylene diureide as a epoxy resin component. The adhesive contains triethyleneglycol diamine or tetraethyleneglycol diamine as a curing agent and a cure accelerator containing piperazine and/or N-aminoethylpiperazine.

U.S. Pat. No. 5,218,063 describes an epoxy adhesive from the reaction product of an epoxy and amine-capped oligomer, an epoxy adduct of a dimer acid, a dicyandiamide and a catalyst. The cured composition can have two distinct glass transition temperatures.

U.S. Pat. No. 5,521,262 describes a liquid epoxy adhesive composition with a stable elastomeric phase. The composition has an oxirane group and an elastomer grafted polyol covalently linked to the epoxy compound other than by the oxirane group.

U.S. Pat. No. 5,629,380 describes an epoxy adhesive composition containing an epoxy resin, an amine curing agent and a catalyst. The catalyst is a calcium salt of a non-sterically hindered tertiary amine.

U.S. Pat. No. 6,486,256 describes an adhesive composition with an epoxy resin, chain extender and polymeric toughener with a separate base catalyst. The cured adhesive composition has at least 50% by weight of the epoxy resin chain extended with an amine or phenolic compound.

U.S. Pat. No. 6,624,260 describes a rubber-modified epoxy resin composition. The composition contains an epoxy resin, a reactive silicon group-containing polyoxyalkylene polymer and a curing agent which includes selected amine compounds.

U.S. Pat. No. 6,645,341 describes a two part epoxide adhesive. The resin component contains an epoxy resin, a polymer polyol and fumed silica. The curing agent contains polyoxyalkyleneamine, an amine terminated butadiene-acrylonitrile polymer, a silane, a polyamide resin, a phenolic accelerator and optionally fumed silica.

U.S. Pub. No. US 2005/0137357 describes an epoxy adhesive resin containing a curative comprising a polyamine, polyamide, a dicyandiamine and an imidazole. The epoxy adhesive can contain toughening agents, adhesion promoters, particulate and reinforcing fillers, pigments, opacifiers, glass beads and microspheres.

The references cited above describe epoxy adhesive compositions which do not meet the ever demanding need for improved formulations with enhanced properties in new and changing applications. For example, many of these compositions are deficient in regard to strength at elevated temperatures, many of the compositions require a high-temperature cure and the compositions are not user friendly in regard to handling properties such as mix ratio, slump resistance and bondable time.

### SUMMARY

The present disclosure relates to an epoxy adhesive composition comprising at least one compound having an average epoxy functionality of at least two and optionally an epoxy-functionalized rubber and a curative comprising a flexible polyamine, a polyamide and optionally an epoxy reactive liquid rubber. The epoxy adhesive composition comprises either the epoxy-functionalized liquid rubber or the epoxy reactive liquid rubber or both. In addition, the epoxy adhesive can further comprise toughening agents, adhesion promoters, particulate and reinforcing fillers, pigments, opacifiers, glass beads, microspheres and other conventional additives. The epoxy composition upon curing has a peel strength of ≧20 piw at 73° F. as measured by ASTM D 1876 and a lap shear strength of >1100 psi at 180° F. as measured by ASTM D 1002.

The disclosure is a novel two-part, low-heat cure epoxy adhesive composition which unexpectedly possesses a unique and a well-balanced combination of properties. Specifically, the adhesive has both high shear and peel strength at temperatures well below room temperature to well above room temperature. The adhesive has a preferred cohesive mode of failure, high impact resistance and high durability in humidity, salt fog and sustained-load aging environments. The adhesive is easy to use, has good slump resistance and an excellent bondable time. This combination of properties has previously not been achieved. The combination of components in the claimed adhesive unexpectedly provide for these properties which are highly desirable in applications such as the vehicle assembly industry.

Another aspect of the present disclosure relates to laminates comprising at least two substrates adhesively formed with the above disclosed epoxy adhesive composition.

A still further aspect of the present disclosure relates to a method of providing a cured epoxy composition. The method comprises mixing the two parts of the above disclosed epoxy adhesive together and permitting the composition to cure at temperatures of about 50° C. to about 230° C. and more typically from about 70° C. to about 120° C.

Still other objects and advantages of the present disclosure will become readily apparent by those skilled in the art from the following detailed description, wherein it is shown and described only in the preferred embodiments, simply by way of illustration of the best mode. As will be realized, the disclosure is capable of other and different embodiments, and its several details are capable of modifications in various obvious respects, without departing from the disclosure. Accordingly, the description is to be regarded as illustrative in nature and not as restrictive.

### DETAILED DESCRIPTION BEST AND VARIOUS MODES

The epoxy composition is formulated in two parts (component (A) and component (B)) with the composition containing a compound with an epoxy functionality in component (A) and the curative component (B) containing a polyamine and a polyamide. Component (A) may also contain an epoxy-functionalized rubber and component (B) may also contain an epoxy reactive liquid rubber. In addition, the epoxy adhesive composition can contain epoxy reactive diluents, colorants, adhesion promoters, glass beads, microspheres, thixotropic agents, fillers, opacifiers and other conventional additives known to be used in epoxy adhesives. The epoxy composition, when cured, has a peel strength of ≧20 piw at 73° F. (ASTM D 1876) and a lap shear of >1100 psi at 180° F. (ASTM D 1002).

The compounds with the epoxy functionality include organic compounds having an average epoxy functionality of at least two. The epoxy compounds can be monomeric or polymeric, and aliphatic, cycloaliphatic, heterocyclic, aromatic or mixtures thereof. Examples of useful epoxy containing compounds include polyglycidylethers of polyhydric alcohols such as ethylene glycol, triethylene glycol, 1,2-propylene glycol, 1,5-pentanediol, 1,2,6-hexanetriol, glycerol, 2,2-bis(4-hydroxy cyclohexyl) propane; polyglycidylethers of aliphatic and aromatic polycarboxylic acids, such as oxalic acid, succinic acid, glutaric acid, terephthalic acid, 2,6-naphthalene dicarboxylic acid and dimerized linoleic acid; polyglycidylethers of polyphenols, such as, bis-phenol A, bis-phenol F, 1,1-bis(4-hydroxyphenyl)ethane, 1,1-bis(4-hydroxyphenyl)butane and 1,5-dihydroxy naphthalene and mixtures thereof. Examples of commmerically available epoxides useful in the invention include those available under the EPON® trademark from Resolution such as EPON® 828. A single compound or mixture of epoxy containing compounds can be used. The epoxy is present in component (A) in amounts from about 20 to 100 wt % of component (A), more typically from about 50 to about 80 wt % of component (A) and most typically from about 60 to about 70 wt % of component (A).

Polyamines used in the curative include aliphatic polyamines, alicyclic polyamines, heterocyclic polyamines, aromatic polyamines, polyamines containing ether linkages in the backbone of the molecule and various mixtures thereof. Suitable polyamines include ethylenediamine, diethylenetriamine, pentaethylenehexylamine, polyetherdiamine, diethylaminopropylamine, triethanolamine, dimethyl aminomethylphenol, bis(aminopropyl)piperazine and mixtures thereof. Mannich bases and tertiary polyamines such as 2,4,6-tris(dimethylaminomethyl) phenol can also be used. Suitable polyamines are available commercially from Air Products Chemical Co. under the Amicure® and Ancamine® trademarks and from Dupont under the tradename Dytek®. Non-limiting examples include Ancamine® AEP (1-(2-aminoethyl) piperazine), Ancamine® K54 (2,4,6,-tri(dimethylaminomethyl)phenol, Amicure® PACM (4,4′-methylene-bis(cyclohexylamine) and Dytek® A (2-methyl-1,5-pentanediamine). The polyamines are typically present in component (B) in amounts from about 4 to about 24 wt % of component (B), more typically from about 10 to about 20 wt % of component (B) and even more typically from about 14 to about 18 wt % of component (B). As accelerators, amines or polyamines are typically present in component (B) in amounts from about 1 to about 5 wt % of component (B).

Polyamides include flexible curatives such as polyamide resins, polyaminopolyamides and polyamides. Flexible curatives are distinguished from non-flexible curatives by the physical properties of the cured formulation. Specifically, with all else being equal, a flexible curative typically provides lower tensile strength and higher elongation. With regard to performance properties, a flexible curative typically provides lower shear and higher peel values. In contrast, a non-flexible curative typically provides higher shear and lower peel values relative to a flexible curative.

Typically the flexible polyamide curatives are the reaction product of a diaminoalkylether and a polycarboxylic acid. Suitable amides derived from the reaction product of the diaminoalkylether and polycarboxylic acid are available commercially from Air Products Chemical Company under the Ancamide® trademark designation. A typical flexible polyamide is Ancamide® 910 which is a condensation product of a dimer acid and diethylene glycol diaminopropyl ether. A single amide or mixture of amides can be used. Typically, the amide is present in amounts from about 10 to about 70 wt % of component (B), more typically in amounts from about 15 to about 30 wt % of component (B) and even more typically from about 20 to about 30 wt % of component (B).

The optional epoxy-functionalized rubber useful in the disclosure includes an epoxy functionalized butadiene homopolymer, an epoxy functionalized butadiene-acrylonitrile copolymer and mixtures of both. Examples include Hycar® reactive liquid polymers marketed by Noveon, and Epon® products marketed by Resolution Performance Products. Specific examples include EPON® 58006 and Hycar® ETBN 1300×40. Typically the epoxy-functionalized rubber, when present in component A, is added in an amount from about 10 to about 70 wt % of component (A), more typically from about 25 to about 50 wt % of component (A) and even more typically from about 25 to about 45 wt % of component (A).

The optional epoxy reactive liquid rubber useful in the disclosure includes amine terminated butadiene-acrylonitrile copolymers, amine terminated butadiene homopolymers and mixtures of both. Examples include Hycar® ATBN 1300×16 and Hycar® ATB 2000×173. The epoxy reactive liquid rubber, when present in component B, is typically added in an amount from about 10 to about 70 wt % of component (B), more typically from about 15 to about 50 wt % of component (B) and even more typically from about 15 to about 30 wt % of component (B).

Toughening agents commonly used with epoxy resins can be used in the present invention. Examples of suitable toughening agents include polymers having both a rubbery phase and a thermoplastic phase. Examples of such polymers include methacrylate/butadiene-styrene, acrylate/-methacrylate/butadiene-styrene and acrylonitrile/butadiene styrene. An example of the foregoing is Paraloid® EXL 2691, a methyl methacrylate butadiene-styrene impact modifier available from Rohm and Haas. Paraloid® is a trademark of Rohm and Haas. Another example of toughening agents are rubber modified liquid epoxy resins. An example of such a resin is Kraton™ RP6565 Rubber available from Resolution. Another example of a class of tougheners includes epoxy rubber adducts. Such adducts include epoxy compounds reacted with liquid or solid butadiene-(meth)acrylonitrile copolymers having at least two groups that are reactive with epoxy groups, such as carboxyl, hydroxyl, mercapto, and the like. Toughening agents can be added to either component (A) or component (B) of the epoxy adhesive composition.

The epoxy adhesive composition of the present disclosure can also include adhesion promoters known to be useful in formulating epoxy based adhesives. Such adhesion promoters include the reaction product of an omega-aminoalkyl trialkoxy silane with a glycidyl ether or polyglycidyl ether. Typical trialkoxy silane linkages include Si(OCH₃)₃ and are capable of hydrolyzing to Si(OH)₃. Suitable compounds include gamma-glycidoxypropyltrimethoxy silane. In addition, organo-silanes containing moieties such as esters, vinyl, methacryloxy, amino, ureido, isocyanurate and isocyanate groups can be used. An example of a suitable amino silane is gamma-aminopropyltriethoxy silane. A single adhesion promoter or mixture of promoters can be used. The promoters are typically added in an amount from 0 to about 8 wt % based on component (A), more typically in an amount from about 1 to about 4 wt % based on component (A).

The epoxy reactive diluents may be added to component (A). Examples include Epodil® 749 marketed by Air Products. The diluents are typically added in amounts from 0 to about 15 wt % of component (A), more typically from about 2 to about 8 wt % of component (A) and even more typically from about 4 to about 6 wt % of component (A).

Other optional ingredients in the epoxy adhesive composition include fillers examples of which include kaolin, talc, mica, calcium carbonate, fumed silica, glass and ceramic beads and microspheres or hollow glass beads both coated and uncoated, wollastonite, carbon fibers, textile fibers and the like. Other optional ingredients include pigments and opacifiers such as ferric oxide, carbon black and titanium dioxide. Any single optional ingredient or mixture of ingredients can be used as required and can be added to either component (A) or (B). The fillers typically include wollastonite added to both components (A) and (B) with typical amounts in component (A) from 0 to about 40 wt % based on component (A), more typically from about 10 to about 30 wt % based on (A) and typically from 0 to about 50 wt % based on component (B), more typically from about 20 to about 40 wt % based on component (B). Other fillers include fumed silica added as a thixotropic agent to both components (A) and (B) typically in an amount of from 0 to about 10 wt % based on each component, more typically from about 1 to about 6 wt % based on each component. Microspheres or hollow glass beads may be added to each component typically in an amount from 0 to about 12 wt % based on each component, more typically from about 3 to about 10 wt % based on each component. Solid glass beads may be added to each component typically in an amount from 0 to about 10 wt % based on each component, more typically from about 1 to about 4 wt % based on each component. In addition pigments and colorants may be added to each component typically in an amount of from 0 to about 10 wt % based on each component, more typically from about 1 to about 4 wt % based on each component.

The epoxy resin adhesive composition can be prepared in any conventional manner known for preparing two part epoxy resin adhesive compositions. The components in each of the two parts are typically mixed by means of known mixing equipment such as high shear mixers and rollers. In the present disclosure, typically the curative portion is prepared by first blending the polyamine and polyamide components prior to adding the remaining components. After formulation, components (A) and (B) are mixed in predetermined ratios prior to application to a substrate. Components (A) and (B) are typically mixed in a ratio by volume of from about 0.1:1 to about 10:1, more typically from about 0.5:1 to about 4:1 and more typically from about 1:1 to about 2:1 of (A):(B).

The epoxy adhesive composition of the present disclosure when cured has a peel strength typically of ≧20 piw at 73° F. (ASTM D 1876), more typically of ≧22 piw at 73° F. and even more typically of ≧24 piw at 73° F. In addition, the epoxy adhesive of the present disclosure typically has a lap shear of >1100 psi at 180° F. (ASTM D 1002), more typically >1200 psi at 180° F. and even more typically >1500 psi at 180° F.

The following examples are for illustrative purposes only and are not intended to limit the scope of the claims.

The lap shear of the cured adhesive compositions is measured at 180° F. by the ASTM D 1002 method. The peel strength (T-Peel) is measured at 73° F. by the ASTM D 1876 method.

### Materials Used in the Examples

EPON® 828—Epoxy resin from Resolution Performance Products.

EPODIL® 749—Epoxy reactive diluent from Air Products.

Stan-Tone® 901EPX04 Black—Black colorant in epoxy resin from Polyone Corp.

Silquest® A-187—Silane Adhesion Promoter from GE Silicones.

Nyad® 325—Wollastonite Filler from Nyco Minerals.

Q-Cel® 6042S—Hollow Glass Beads from Potters Industries.

Aerosil® R202—Fumed Silica From Degussa.

Solid Glass Beads—10 mil from Cataphote.

Ancamide® 350A—Non-flexible Polyamide from Air Products.

Ancamide® 910—Flexible Polyamide from Air Products.

EPI-Cure® 3164—Flexible Polyamide from Resolution.

Hycar® ATBN—Amine Terminated Butadiene-Acrylonitrile Copolymer from Noveon.

Amicure® PACM—Amine Curing Agent from Air Products.

Ancamine®AEP—Amine Curing Agent from Air Products.

Ancamine®K54—Amine Accelerator from Air Products.

The examples given in the disclosure are prepared and tested as follows:

Preparation of Component A or Component B. The liquid inputs were blended using a SpeedMixer™ (FlackTek Inc.) for 30 seconds at 2500 rpm. The solid inputs were then added and blended for 60 seconds at 2500 rpm. Typical scale was 100 grams.

Mixing Component A+Component B. The two components were mixed and degassed in a Vacuum Power Mixer Plus (Whip Mix Corp.) for 2 min at 29″ vacuum. The mixture was pulled up into a wide-tipped syringe for dispensing onto the substrate. Typical scale was 100 grams. The amounts of Component A and Component B were such to give a stoichiometric epoxy:amine ratio of 1.1:1. Stoichiometry was calculated from equivalent weights as is standard in the industry. Equivalent weights were provided by the raw material suppliers.

Preparation of Substrate. The substrate was aluminum 5052 H32. Coupons for lap shear testing were 1×4×0.050″. Coupons for T-peel testing were 1×12×0.050″. The substrate was abraded with a bristle disc (3M Roloc™) then wiped with a towel moistened with isopropyl alcohol.

Bonding. The adhesive was applied to a coupon that was then mated with a second coupon and clamped using Hoffmann open-jaw screw clamps. Bond thickness was maintained by 10 mil solid glass spacer beads in the formulation.

Cure. After 1 hour at 73° F., the clamped assembly was placed in an oven at 210° F. for 0.5 hour.

Testing. Lap shear samples were tested at 180° F. by ASTM D1002 and T-peel samples were tested at 73° F. by ASTM D1876. Results were the average of five samples. All failure modes were cohesive.

TABLE 1
Formulation of the Examples

| | | | | | | | | | Comparative | | | | |
|---|---|---|---|---|---|---|---|---|---|---|---|---|---|
| | Examples | | | | | | | | Examples | | | | |
| | 1 | 2 | 3 | 4 | 5 | 6 | 7 | 8 | 1 | 2 | 3 | 4 | 5 |
| Component (A) WT % | | | | | | | | | | | | | |
| EPON ® 828 | 64 | 64 | 64 | 64 | 64 | 64 | 64 | 36 | 64 | 64 | 64 | 64 | 25 |
| EPON ® 58006 | — | — | — | — | — | — | — | 28 | — | — | — | — | 39 |
| EPODIL ® 749 | 4 | 4 | 4 | 4 | 4 | 4 | 4 | 4 | 4 | 4 | 4 | 4 | 4 |
| Stan-Tone ® 901EPX04 Black | 2 | 2 | 2 | 2 | 2 | 2 | 2 | 2 | 2 | 2 | 2 | 2 | 2 |
| Silquest ® A-187 | 2 | 2 | 2 | 2 | 2 | 2 | 2 | 2 | 2 | 2 | 2 | 2 | 2 |
| Nyad ® 325 | 18 | 18 | 18 | 18 | 18 | 18 | 18 | 18 | 18 | 18 | 18 | 18 | 18 |
| Q-Cel ® 6042S | 6 | 6 | 6 | 6 | 6 | 6 | 6 | 6 | 6 | 6 | 6 | 6 | 6 |
| Aerosil ® R202 | 3 | 3 | 3 | 3 | 3 | 3 | 3 | 3 | 3 | 3 | 3 | 3 | 3 |
| Solid Glass Beads | 1 | 1 | 1 | 1 | 1 | 1 | 1 | 1 | 1 | 1 | 1 | 1 | 1 |
| Component (B) WT % | | | | | | | | | | | | | |
| Ancamide ® 350A | — | — | — | — | — | — | — | — | 40 | — | 20 | 20 | — |
| Ancamide ® 910 | 20 | 30 | 10 | — | 20 | 20 | 20 | 26 | — | 40 | 20 | — | 20 |
| EPI-Cure ® 3164 | — | — | — | 20 | — | — | — | — | — | — | — | — | — |
| Hycar ® 1300 × 16 | 20 | 10 | 30 | 20 | 20 | 20 | 20 | — | — | — | — | 20 | — |
| Amicure ® PACM | 14 | 14 | 14 | 14 | — | 14 | 14 | 14 | 14 | 14 | 14 | 14 | 14 |
| Anacamine ® AEP | — | — | — | — | 11.5 | — | — | — | — | — | — | — | — |
| Ancamine ® K54 | 3 | 3 | 3 | 3 | 3 | 0 | 1 | 3 | 3 | 3 | 3 | 3 | 3 |
| Nyad ® 325 | 32 | 32 | 32 | 32 | 34.5 | 32 | 32 | 32 | 32 | 32 | 32 | 32 | 32 |
| Q-Cell ® 6042S | 8 | 8 | 8 | 8 | 8 | 8 | 8 | 8 | 8 | 8 | 8 | 8 | 8 |
| Aerosil ® R202 | 3 | 3 | 3 | 3 | 3 | 3 | 3 | 3 | 3 | 3 | 3 | 3 | 3 |

TABLE 2
Experimental Results

| | Lap Shear | Peel Strength at |
|---|---|---|
| | at 180° F. (PSi) | 73° F. (Piw) |
| Example | | |
| 1 | 1688 | 25 |
| 2 | 1391 | 20 |
| 3 | 1611 | 21 |
| 4 | 1392 | 20 |
| 5 | 1234 | 25 |
| 6 | 1184 | 27 |
| 7 | 1537 | 26 |
| 8 | 1292 | 20 |
| Comparative | | |
| Example | | |
| 1 | 2335 | <3 |
| 2 | 1358 | 15 |
| 3 | 2121 | <3 |
| 4 | 2183 | 18 |
| 5 | 1643 | 15 |

Inspection of the experimental results given in Table 2 shows that the composition of the present disclosure has a combination of both high lap shear and high peel strength relative to the comparative examples. The data illustrate that without the claimed liquid rubber component (Comparative Examples 1-3) that the recited properties are not achieved. The data also illustrate that the recited properties are achieved with a flexible curative Examples (1-7) but that the disclosed properties are not achieved with a non-flexible curative (Comparative Examples 1, 3 and 4). In addition, Examples 1-7 illustrate a composition comprising the optional epoxy reactive liquid rubber (Hycar® 1300×16) and Example 8 illustrates a composition comprising the optional epoxy-functionalized liquid rubber component (EPON® 58006).

The epoxy adhesive compositions can be used for bonding metal to metal, metal to plastic, plastic to plastic, and to bond wood and wood products. Examples of metals include steel cold rolled, galvanized steel, titanium, aluminum, magnesium and the like. Examples of plastic substrates include polypropylene, polycarbonate, polyester, polyurethane, polyester. ABS and the like. The epoxy adhesive compositions can be used in assembling parts for automobiles, aircraft, boats, refrigeration units, etc.

Cured epoxy adhesive compositions of this disclosure are especially useful as structural adhesives for bonding metal to the same or different surfaces such as sheet molding compounds (SMC), fiber glass reinforced polyester (FRP), structural reaction injected molded (SRIM), resin transfer moldings (RTM) and the like. Structural adhesives are used by application of the adhesive to a surface of a part and positioning the surface of a second part over the adhesive covered surface of the first part. The process can be repeated as required.

The term “comprising” (and its grammatical variations) as used herein is used in the inclusive sense of “having” or “including” and not in the exclusive sense of “consisting only of”. The terms “a” and “the” as used herein are understood to encompass well as the singular.

The foregoing description illustrates and describes the present disclosure. Additionally, the disclosure shows and describes only the preferred embodiments of the disclosure, but, as mentioned above, it is to be understood that it is capable of changes or modifications within the scope of the concept as expressed herein, commensurate with the above teachings and/or skill or knowledge of the relevant art. The embodiments described hereinabove are further intended to explain best modes known of practicing the invention and to enable others skilled in the art to utilize the disclosure in such, or other, embodiments and with the various modification required by the particular applications or uses disclosed herein. Accordingly, the description is not intended to limit the invention to the form disclosed herein. Also, it is intended that the appended claims be construed to include alternative embodiments.

All publications, patents and patent applications cited in this specification are herein incorporated by reference, and for any and all purposes, as if each individual publication, patent or patent application were specifically and individually indicated to be incorporated by reference. In the case of inconsistencies, the present disclosure will prevail.

We claim:

1. An epoxy adhesive composition comprising components (A) and (B) wherein:
component (A) comprises at least one compound having an average epoxy functionality of at least two and optionally an epoxy-functionalized liquid rubber and
component (B) comprises a curative comprising,
i. a polyamine,
ii. a flexible polyamide and
iii. optionally an epoxy reactive liquid rubber,
wherein the epoxy adhesive composition comprises either the epoxy-functionalized liquid rubber in component (A) or the epoxy reactive liquid rubber in component (B) or both and wherein the epoxy adhesive composition upon curing has a peel strength of ≧20 piw at 73° F. as measured by ASTM D 1876 and a lap shear strength of >1100 psi at 180° F. as measured by ASTM D 1002.

2. The epoxy adhesive composition of claim 1, wherein the at least one compound having an average epoxy functionality of at least two is selected from the group consisting of polyglycidylethers of polyhydric alcohols, polyglycidylethers of aliphatic or aromatic polycarboxylic acids, polyglycidylethers of polyphenols, diglycidyl ether of bisphenol A and mixtures thereof.

3. The epoxy adhesive composition of claim 1, wherein the polyamine is selected from the group consisting of aliphatic polyamines, alicyclic polyamines, heterocyclic polyamines, aromatic polyamines, polyamines containing ether linkages in the backbone of the molecule and mixtures thereof.

4. The epoxy adhesive composition of claim 1, wherein the polyamide is selected from the group consisting of polyamide resins, polyamino polyamides, polyamides that are the reaction product of a diaminoalkyl ether and a carboxylic acid, polyamides that are the reaction product of a dialkylene glycol diaminoalkyl ether and a carboxylic acid, polyamides that are the reaction product of a dialkylene glycol diaminoalkyl ether and a polycarboxylic acid, polyamides that are the reaction product of diethylene glycol diaminopropyl ether and a dicarboxylic acid and mixtures thereof.

5. The epoxy adhesive composition of claim 1, wherein component (A) contains the epoxy functionalized liquid rubber and wherein the epoxy functionalized liquid rubber is selected from the group consisting of epoxy functionalized butadiene homopolymers, epoxy functionalized butadiene-acrylonitrile copolymers and mixtures thereof.

6. The epoxy adhesive composition of claim 1, wherein component (B) contains the epoxy reactive liquid rubber and wherein the epoxy reactive liquid rubber is selected from the group consisting of amine terminated butadiene-acrylonitrile copolymers, amine terminated butadiene homopolymers and mixtures thereof.

7. The composition of claim 1, further comprising a toughening agent.

8. The composition of claim 1, further comprising an adhesion promoter.

9. The composition of claim 1, further comprising microspheres.

10. The composition of claim 1, further comprising a mineral filler.

11. The composition of claim 1, further comprising a reactive epoxy diluent.

12. The composition of claim 1, further comprising a colorant.

13. The composition of claim 1, further comprising an accelerator.

14. The composition of claim 1, further comprising a thixotropic agent.

15. The epoxy adhesive composition of claim 1, wherein the epoxy adhesive composition upon curing has a peel strength of ≧22 piw at 73° F. as measured by ASTM D 1876 and a lap shear strength of >1200 psi at 180° F. as measured by ASTM D 1002.

16. The epoxy adhesive composition of claim 1, wherein the epoxy adhesive composition upon curing has a peel strength of ≧24 piw at 73° F. as measured by ASTM D 1876 and a lap shear strength of >1500 psi at 180° F. as measured by ASTM D 1002.

17. An epoxy adhesive composition comprising components (A) and (B) wherein:
component (A) comprises at least one compound having an average epoxy functionality of at least two, an epoxy reactive diluent, a colorant in epoxy resin, an adhesion promoter, a filler, hollow glass beads, a thixotropic agent, solid glass beads and optionally an epoxy-functionalized liquid rubber and
component (B) comprises a curative comprising a polyamine, a flexible polyamide, an accelerator, a filler, hollow glass beads, a thixotropic agent and optionally an epoxy reactive liquid rubber,
wherein the epoxy adhesive composition comprises either the epoxy-functionalized liquid rubber in component (A) or the epoxy reactive liquid rubber in component (B) or both and wherein the epoxy adhesive composition upon curing has a peel strength of ≧20 piw at 73° F. as measured by ASTM D 1876 and a lap shear strength of >1100 psi at 180° F. as measured by ASTM D 1002.

18. The epoxy adhesive composition of claim 17, wherein component (A) comprises from about 20 to about 80 wt % of the at least one compound having an average epoxy functionality of at least two based on component (A), from about 2 to about 8 wt % of the epoxy reactive diluent based on component (A), from about 1 to about 4 wt % of the colorant in epoxy resin based on component (A), from about 1 to about 4 wt % of the adhesion promoter based on component (A), from about 10 to about 30 wt % of the filler based on component (A), from about 1 to about 6 wt % of the thixotropic agent based on component (A), from about 3% to about 10% of the hollow glass beads based on component (A) and when present in component (A) from about 10 to about 50 wt % of the epoxy-functionalized liquid rubber based on component (A)
and wherein component (B) comprises from about 4 to 24 wt % of the polyamine based on component (B), from about 10 to about 30 wt % of the flexible polyamide based on component (B), from about 1 to about 5 wt % of the accelerator based on component (B), from about 20 to about 40 wt % of the filler based on component (B), from about 3 to about 10 wt % of the hollow glass beads based on component (B), from about 1 to about 6 wt % of the thixotropic agent based on (B) and when present in component (B) from about 15 to about 50 wt % of the epoxy reactive liquid rubber based on component (B).

19. The composition as claimed in claim 18 wherein the flexible polyamide is Ancamide® 910 or Epi-cure® 3164.

20. A laminate, comprising at least two substrates wherein the substrates are adhesively joined with the epoxy adhesive composition of claim 1.

21. The laminate of claim 20, wherein at least one substrate is a metal.

22. The laminate of claim 20, wherein at least one substrate is a plastic.

23. The laminate of claim 20, wherein at least one substrate is glass.

24. The laminate of claim 20, wherein at least one substrate is wood or a wood-based product.

25. A cured epoxy adhesive composition produced by a method comprising mixing components (A) and (B) of the epoxy adhesive composition of claim 1 to form a mixture and then allowing the mixture to cure.

26. A laminated article produced by a method comprising mixing components (A) and (B) of the epoxy adhesive composition of claim 1 to form a mixture then applying the mixture to at least one of at least two substrates then joining the substrates with the mixture between the substrates and then allowing the mixture to cure.

27. A method for curing the epoxy adhesive composition of claim 1 comprising mixing components (A) and (B) to form a mixture then heating the mixture to a temperature of from about 50° C. to about 230° C. to form a cured epoxy adhesive composition.
